(19) United States
(12) Patent Application Publication
(10) Pub. No.: US 2017/0042223 A1
(43) Pub. Date: Feb. 16, 2017

(54) Device and method for containing and filtering exhaled smoke

(71) Applicant: Howard Park, Laguna Woods, CA (US)

(72) Inventor: Howard Park, Laguna Woods, CA (US)

(21) Appl. No.: 14/825,544

(22) Filed: Aug. 13, 2015

(51) Int. Cl. A24F 13/00; B01D 46/00

(52) U.S. Cl. CPC A24F 13/00; B01D 46/0002

(57) ABSTRACT

A device and method for containing and filtering exhaled smoke. When a smoker exhales smoke into the mouthpiece, the smoke is initially stored in a bag or bellows. Pressure on the bag or bellows, provided by the material itself, gravity, or a spring, forces the smoke through a filter before being released into the surrounding air.

### CROSS-REFERENCE TO RELATED APPLICATIONS

Not applicable

### BACKGROUND OF THE INVENTION

This invention relates to devices for tobacco smoking (USPC Class 131), specifically for filtering smoke exhaled by a smoker of tobacco or similar substance.

It is now widely accepted within the medical profession and in society at large that second-hand smoke may be harmful to the health of those exposed to it. As a result, many new laws and restrictions have been adopted to protect people from second-hand smoke. At the same time, smokers continue to have the right and the desire to smoke. As such, there are many environments, from the home to the workplace to public spaces, in which a smoker may wish to smoke without exposing those around him or her to second-hand smoke.

In addition to its health effects, second-hand smoke creates an odor that many people find unpleasant or offensive. This odor may permeate articles exposed to it, such as clothing and furniture, often necessitating expensive remediation efforts.

There are many known types of portable devices for filtering cigarette smoke. Some are capable of dealing with exhaled smoke; others deal only with “sidestream” smoke (the smoke that comes directly from a burning cigarette). Gidding (U.S. Pat. No. 8,109,276) represents the state of the art of such devices, but there are many similar devices, such as Lichtenberg (U.S. Pat. No. 6,006,757), Bowen (U.S. Pat. No. 5,495,859 inter alia), and McCann (U.S. Pat. No. 4,993,435). One drawback of all known devices for filtering exhaled smoke is that they require the user to push the smoke through the filter either using his or her own lung power, which may be difficult for some people and may cause discomfort or even pain, such as sore throat, or using a fan, which requires electrical power.

There are also several known types of portable devices for containing cigarette smoke, such as Rojas Henao (U.S. Pat. No. 5,396,907), Takagi (U.S. Pat. No. 5,048,545), Nare (U.S. Pat. No. 4,922,931), and Sahar (U.S. Pat. No. 4,807,646). One drawback of all known devices for containing cigarette smoke is that they must be emptied on a regular basis into an environment in which the contained smoke may dissipate harmlessly. Not only is this inconvenient, but such an environment may be difficult to find.

Finally, there are many types of environmental air filters that claim to be able to filter smoke. However, they operate only on smoke that has already been emitted into the environment, so they are capable only of mitigating the problem, not preventing it.

For all of the foregoing reasons, there is need for a device that contains and filters second-hand smoke before it enters the environment, that does not require regular emptying, and that is easy to operate, requiring neither forceful exhalation nor electrical power.

### BRIEF SUMMARY OF THE INVENTION

The present invention provides a device that contains and filters exhaled smoke. When a smoker exhales smoke into the mouthpiece, the smoke passes through a non-return valve, along an inlet tube, along a communicating passage, through a second non-return valve, and into an expandable container. Some smoke particles are removed here by adhesion to the interior surface of the container. Slight pressure on the container, in the form of gravity or a spring, causes the remaining smoke to pass through the attached filter, along an outlet passage, and into the surrounding environment.

This invention overcomes the drawbacks of all known devices. First, unlike environmental air filters, the present device contains and filters exhaled smoke before it enters the surrounding environment. Second, unlike all known devices for containing cigarette smoke, the present device does not need regular emptying into a separate environment, instead filtering the smoke in place. And third, unlike all known devices for filtering exhaled smoke, the present device first stores the smoke in an expandable container, which has many benefits. One benefit is that it removes some smoke particles from the air prior to filtration. Another benefit is that it requires less pressure to blow smoke into an expandable container than is required to blow smoke directly through a filter. A third benefit is that it mitigates changes in air pressure over time, allowing air to pass through the filter over a longer time period, thus increasing the filter's efficiency.

This invention overcomes an inherent deficiency of previous devices for filtering exhaled smoke. The amount of filtration is a product of the thickness of the filter and the time of filtration. In layman's terms, the thicker the filter, the more smoke will be removed. However, a thicker filter is more difficult to operate, as it requires greater pressure to push the smoke through the filter in a given amount of time. This inherent negative correlation is solved by interposing a storage component between the exhalation and the filtration.

### BRIEF DESCRIPTION OF THE DRAWING

FIG. 1 is a vertical section of the device.

### DETAILED DESCRIPTION OF THE INVENTION

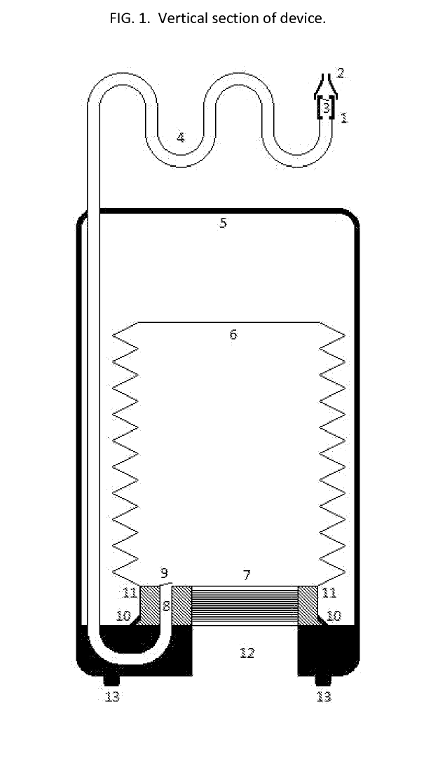

The device is shown in FIG. 1, sectioned vertically to reveal its interior components. When a smoker exhales smoke into the mouthpiece 1, the smoke passes through a non-return valve 3, along an inlet tube 4, along a communicating passage 8, through a second non-return valve 9 and into an expandable container 6 inside a housing 5. In the preferred embodiment, gravity causes the expandable container 6 to deflate, forcing the contained smoke to pass through the filter 7, along an outlet passage 12, and into the surrounding environment. In other embodiments, an additional weight, a spring, or fans may be used to provide the necessary force. Attachment points 10 detachably attach the filter assembly 11 to the housing 5, so that the expandable container 6 and the filter 7 may be replaced in a single action.

In the preferred embodiment, the mouthpiece 1 is constructed in such a way that a mouthpiece tip 2 may be detachably attached to the mouthpiece 1, so that it may be replaced for hygienic or aesthetic purposes. The mouthpiece 1 also comprises a non-return valve 3, in the form of a flap or sphincter resting in the closed position, which prevents smoke from flowing back out of the inlet tube 4.

The inlet tube 4 may be any type of flexible, non-toxic tubing such as vinyl, of any convenient length.

In two alternative embodiments, the expandable container 6 may comprise either a bag, made of a smoke attractive material such as Low Density Polyethylene (LDPE), preferably pleated to increase surface area, and optionally coated with a deodorizing ingredient, or a bellows, preferably made of a smoke attractive material such as Low Density Polyethylene (LDPE) and optionally coated with a deodorizing ingredient. When smoke flows through the inlet tube 4 and past the second non-return valve 9, it inflates the expandable container 6 and is stored here temporarily. In the preferred embodiment, the expandable container 6 comprises a bellows made of a resilient plastic such as High Density Polyethylene (HDPE) that comes to rest in the deflated position. When inflated, the bellows tends to deflate slowly, forcing the stored smoke to pass through the filter 7 over a period of time.

The filter assembly 11, comprising the filter 7, the communicating passage 8, the second non-return valve 9, and the expandable container 6, may be made of any rigid, durable, non-toxic material such as High Density Polyethylene (HDPE) and is detachably attached to the housing 5, so that these replaceable components may be attached or detached in a single action. When the user attaches the filter assembly 11 in its appropriate site, a seal is effected between the inlet tube 4 and the communicating passage 8, and between the filter 7 and the outlet passage 12.

In the preferred embodiment, the filter 7 comprises three layers, the first layer consisting of a high-efficiency particulate air (HEPA) filter for removing smoke particles, the second layer consisting of an activated carbon filter for removing gases, and the third layer consisting of a deodorizing agent.

The housing 5 may be made of any type of rigid, durable, non-toxic material such as High Density Polyethylene (HDPE). In the preferred embodiment, rubber feet 13 are attached to the bottom, so that the outlet passage 12 will not be blocked when the device is placed on a flat surface.

The preferred embodiments described above are in no way intended to limit the claims made elsewhere in this application.

I claim:

1. A device and method for containing and filtering exhaled smoke, so that smoke exhaled by a smoker will be temporarily held in a container such as a bag or a bellows, then filtered before entering the surrounding environment, said device comprising:
a housing;
a mouthpiece;
an expandable container, said container for holding smoke prior to filtration;
an inlet tube between said mouthpiece and said container, said inlet tube for allowing exhaled smoke to flow into said container;
a filter attached to and communicating with one side of said container, said filter for removing smoke particles as air passes through; and
an outlet passage between said filter and exterior of said housing, said outlet passage for allowing filtered air to flow into said environment.

2. The device of claim 1 wherein said mouthpiece comprises a valve for preventing smoke from flowing from said inlet tube into said environment.

3. The device of claim 1 wherein said expandable container comprises a bag.

4. The device of claim 3 wherein said bag is positioned such that said filter faces downward so that the force of gravity deflates said bag, causing the smoke contained therein to pass through said filter.

5. The device of claim 3 wherein said bag abuts a spring such that said spring pushes against and deflates said bag, causing the smoke contained therein to pass through said filter.

6. The device of claim 1 wherein said expandable container comprises a bellows.

7. The device of claim 6 wherein said bellows is positioned such that said filter faces downward so that the force of gravity deflates said bellows, causing the smoke contained therein to pass through said filter.

8. The device of claim 6 wherein said bellows abuts a spring such that said spring pushes against and deflates said bellows, causing the smoke contained therein to pass through said filter.

9. The device of claim 1 wherein said outlet passage contains a deodorizing ingredient.

10. The device of claim 3 wherein said bag is coated with a deodorizing ingredient.

11. The device of claim 1 wherein said mouthpiece may be removed and replaced with a new mouthpiece.

12. The device of claim 1 wherein said filter is detachably attached to said outlet passage and said container is detachably attached to said inlet tube, so that said filter and said container may be removed and replaced with a new filter and container.

13. The device of claim 12 wherein a filter assembly, comprising said filter and a communicating passage, said communicating passage comprising a passage for allowing exhaled smoke to flow from said inlet tube to said container and a non-return valve, is detachably attached to both said outlet passage and said inlet tube when positioned to align with said filter assembly, so that said filter may be attached to said outlet passage and said communicating passage may be attached to said inlet tube using a single set of attachment points.

14. The device of claim 1 wherein a fan positioned inside said communicating passage causes smoke to flow from said inlet tube to said container.

15. The device of claim 1 wherein a fan positioned inside said outlet passage causes smoke contained in said container to pass through said filter and out said outlet passage.
